(19) United States
(12) Patent Application Publication
(10) Pub. No.: US 2004/0123487 A1
(43) Pub. Date: Jul. 1, 2004

(54) Assembling structure between guide funnel and inlet duct in gas combustion device for clothes dryer

(75) Inventor: In Hee Han, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 10/660,726

(22) Filed: Sep. 12, 2003

(30) Foreign Application Priority Data
Sep. 12, 2002 (KR) P 2002-00055458

(51) Int. Cl. F26B 11/02

(52) U.S. Cl. 34/595

(57) ABSTRACT

The present invention relates to a clothes dryer, in which a fitting structure of a guide funnel to an inlet duct of a gas combustion device is improved for preventing the guide funnel from being fluid in the fitting. For this, the present invention provides a fitting structure of a guide funnel to an inlet duct of a gas combustion device in a clothes dryer, including grooves 200 respectively recessed into a flow passage in left/right sides of an outlet part of the guide funnel 20, and projections 120 respectively fit to the grooves in the guide funnel 20 on an inlet side of an inlet duct 12 the outlet part of the guide funnel 20 is inserted thereto, which clothes dryer having a drying drum 1 for introduction of a drying object therein, a rear supporter 9 for supporting a rear part of the drying drum 1, the inlet duct 12 fitted to the rear supporter 9 for serving as a passage for supplying hot air to the drying drum 1, the guide funnel 20 fitted to an inlet side of the inlet duct 12, a mixing pipe 24 fitted to an inlet side of the guide funnel 20, for mixing the gas sprayed from a gas nozzle 22 and primary air, the gas nozzle 22 fitted to a position opposite to the inlet of the mixing pipe 24, a valve 30 fitted for controlling supply and supply rate of the gas to the gas nozzle 22, and an igniter 26 at a fore end of the mixing pipe 24 for igniting mixture gas.

This application claims the benefit of Korean Application(s) No. P2002-0055458 filed on Sep. 12, 2002, which is/are hereby incorporated by reference.

### BACKGROUND OF THE INVENTION

1. Field of the Invention

The present invention relates to clothes dryers, and more particularly, to an assembly structure of a guide funnel and an inlet duct of a gas combustion device for burning gas to produce hot air to dry a drying object introduced into a drying drum.

2. Discussion of the Related Art

FIG. 1 illustrates a disassembled perspective view showing a related art clothes dryer. As shown, there is a drying drum 1 mounted in a cabinet (not shown) which forms an exterior of the clothes dryer. The drying drum 1 is cylindrical, with opened front and rear parts, and a belt groove 2 in a middle part of an outside circumference for winding a belt (not shown) driving by a separate driving source thereon.

The drying drum 1 is provided with a drying chamber 5 therein for carrying out drying, and a plurality of lifters 6 on an inside thereof for lifting and dropping a drying object in the drying chamber 5 to upside down the drying object to improve a drying efficiency.

The drying drum 1 has a front supporter 7 and a rear supporter 9 at opposite front and rear ends thereof. The front supporter 7 and the rear supporter 9 close a front side and a rear side of the drying drum 1, to form a drying chamber 5, and support the front end and the rear end of the drying drum 1.

There are sealing members 10 between the front supporter 7 and the rotatable drying drum 1, and between the rear supporter 9 and the rotatable drying drum 1, for prevention of leakage. Of course, the front supporter 7 and the rear supporter 9 are provided with a plurality of rollers (not shown) at relevant positions of the front and rear parts of the drying drum 1 for supporting the drying drum 1.

In the meantime, the front supporter 7 has a through hole 8 for making the drying chamber 5 and an outside of the drying chamber 5 in communication. The through hole 8 is opened/closed with a door (not shown) selectively.

The rear supporter 9 has an inlet duct 12 mounted thereto in communication with the drying chamber 5 for serving as a passage of the hot air to be supplied to the drying chamber 5.

The front supporter 7 has an outlet assembly 13, which is a part for escaping of the air from the drying chamber 5, at one side thereof at a lower end of the through hole 8. The outlet assembly 13 has a lint filter 14.

The lint filter 14 filters foreign matters (for an example, threads, or dust) from air escaping the drying chamber 5.

In the meantime, there is a lint duct 15 in communication with the outlet assembly 13. The lint filter 14 is positioned even inside of the lint duct 15. There is a blower 17 connected to the lint duct 15 for drawing air from the drying chamber 5 through the line duct 15. The blower 17 is mounted in a blower housing 18.

The blower housing 18 has one side in communication with the lint duct 15, and the other side connected to an air discharge pipe 19. Therefore, the air escaped from the drying chamber 5 and passed through the lint duct 15 is discharged to an outside of the dryer through the discharge pipe 19 by a blowing action of the blower 17.

In the meantime, there is a guide funnel 20 connected to an inlet side of the inlet duct 12. The guide funnel 20 guides hot air produced by combustion of gas to the inlet side of the inlet duct.

There is a mixing pipe 24 on an inlet side of the guide funnel 20 for mixing gas sprayed from a gas nozzle 22 and primary air.

An outlet of the mixing pipe 24 is positioned in a state spaced a distance inward from the inlet of the guide funnel 20.

The gas nozzle 22 is positioned opposite to the inlet of the mixing pipe 24, and has a valve 30 for controlling supply and a supply rate of the gas.

The valve 30 has a gas pipeline 23 connected thereto for continuous supply of the gas from a separate gas supply source.

According to this, the gas sprayed from the gas nozzle 22 and the external air introduced thereto through the inlet of the mixing pipe, i.e., primary air, are mixed in the mixing pipe 24.

There is an igniter 26 in a fore end of the mixing pipe 24 for igniting the mixing gas.

The operation of the related art clothes dryer will be described.

Upon introducing drying objects (for an example, laundry) into the drying chamber 5 in the drying drum 1, closing the door, and pressing an operation button, the drying drum 1 rotates as the belt wound in the belt groove 2 is driven by a separate driving source.

When the blower 17 is driven, air is drawn from the drying chamber 5 through the lint duct 15. In such as case, external air is introduced into the drying chamber 5 through the inlet duct 12 owing to a pressure difference.

In this instance, the air supplied to the inlet duct 12 is heated with a gas burner to a relative high temperature before introduction thereto.

That is, as the gas is sprayed into the mixing pipe 24 from the gas nozzle 22, and the primary air introduced into the inlet of the mixing pipe 24, and the gas and the air are mixed to each other in the mixing pipe 24, and ignited with the igniter 26 initially at the outlet of the mixing pipe 24, the mixture gas burns. As a thermal energy generated when the gas burns heats the air introduced into an inside of the guide funnel 20, to produce hot air.

In the meantime, the hot air is introduced into the drying chamber 5 in the drying drum 1 through the inlet duct 12. The hot air having moisture absorbed from the laundry in the drying chamber 5 escapes the drying chamber 5 through the outlet assembly 13. The escape of the air through the outlet assembly 13 is made by a suction force of the blower 17. Dust and thread are filtered from the air escaping the outlet assembly 13 at the lint filter 14.

However, there is a problem in an assembly structure of the guide funnel 20 and the inlet duct 12 in the related art.

That is, since both the guide funnel 20 and an inlet of the inlet duct 12 are cylindrical, fitting of the guide funnel 20 to the inlet of the inlet duct 12 has not been easy, because the guide funnel 20 is fluid.

In other words, since the cylindrical guide funnel is not fixed at a position of the inlet of the inlet duct 12, but rotative in a clock, or anti-clock wise direction, the fitting has not been easy.

### SUMMARY OF THE INVENTION

An object of the present invention, devised to solve the related art problem, lies on providing an improved fitting structure of a guide funnel to an inlet duct in a clothes dryer having a gas combustion device for burning a gas to produce hot air for drying a drying object introduced into a drying drum, for improving workability of the fitting by preventing the guide funnel from being fluid in fitting the guide funnel to the inlet duct.

To achieve the object of the present invention, there is provided a fitting structure of a guide funnel to an inlet duct of a gas combustion device in a clothes dryer, including grooves respectively recessed into a flow passage in left/right sides of an outlet part of the guide funnel, and projections fit to the grooves in the guide funnel on an inlet side of an inlet duct the outlet part of the guide funnel is inserted thereto, which clothes dryer has a drying drum for introduction of a drying object therein, a rear supporter for supporting a rear part of the drying drum, the inlet duct fitted to the rear supporter for serving as a passage for supplying hot air to the drying drum, the guide funnel fitted to an inlet side of the inlet duct, a mixing pipe fitted to an inlet side of the guide funnel, for mixing the gas sprayed from a gas nozzle and primary air, the gas nozzle fitted to a position opposite to the inlet of the mixing pipe, a valve fitted for controlling supply and supply rate of the gas to the gas nozzle, and an igniter at a fore end of the mixing pipe for igniting mixture gas.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a disassembled perspective view showing a related art clothes dryer.

FIG. 2 illustrates a side section showing key parts in the related art.

FIG. 3 illustrates a longitudinal section across a line I-I in FIG. 2.

FIG. 4 illustrates a side section showing key parts of the present invention.

FIG. 5 illustrates a longitudinal section across a line II-II in FIG. 4.

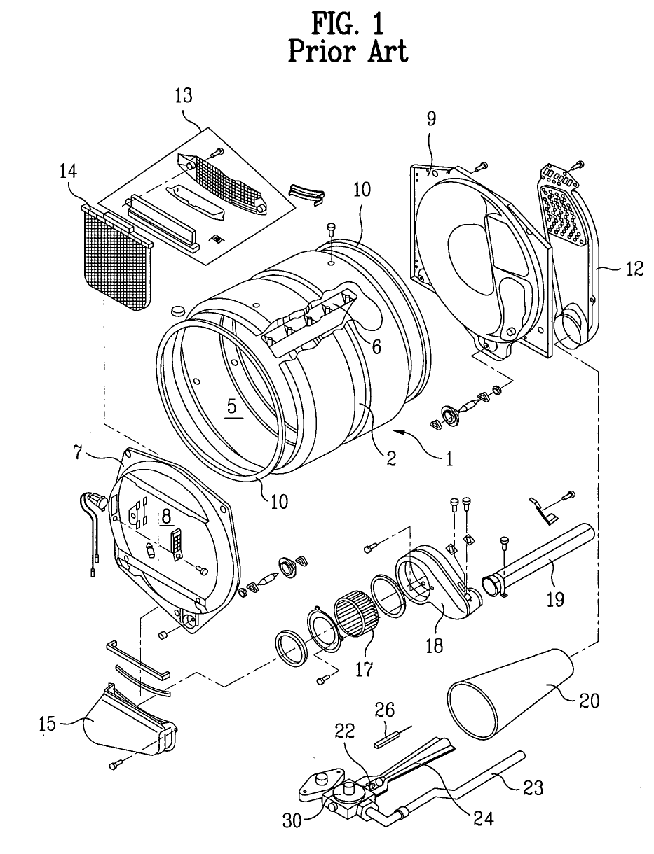

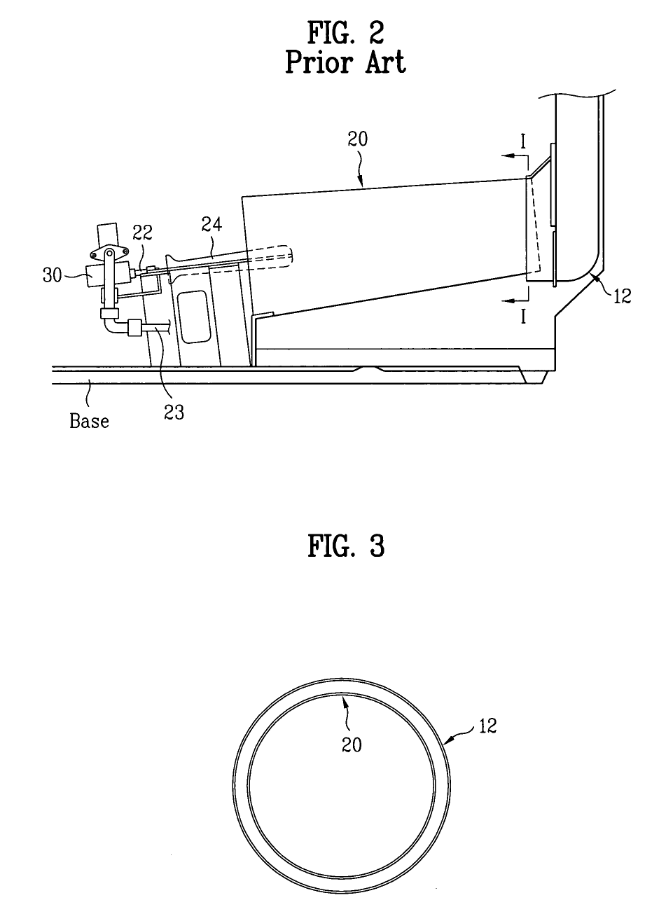

### DETAILED DESCRIPTION OF THE PREFERRED EMBODIMENT(S)

Reference will now be made in detail to the preferred embodiment(s) of the present invention, examples of which are illustrated in the accompanying drawings. Throughout the drawings, like elements are indicated using the same or similar reference designations where possible.

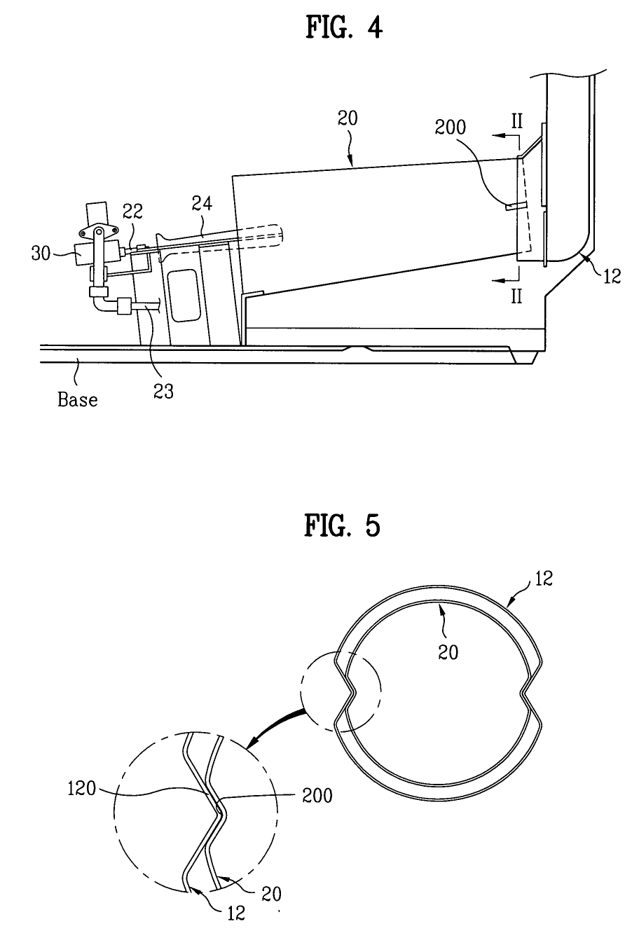

An embodiment of the present invention will be described in detail with reference to the attached drawings FIGS. 4 and 5.

FIG. 4 illustrates a side section showing key parts of the present invention, and FIG. 5 illustrates a longitudinal section across a line II-II in FIG. 4, wherein a fitting structure of a guide funnel to an inlet duct of a gas combustion device in a clothes dryer of the present invention includes grooves 200 respectively recessed into a flow passage in left/right sides of an outlet part of the guide funnel 20, and projections 120 fit to the grooves in the guide funnel 20 on an inlet side of an inlet duct 12 the outlet part of the guide funnel 20 is inserted thereto, which clothes dryer has a drying drum 1 for introduction of a drying object therein, a rear supporter 9 for supporting a rear part of the drying drum 1, the inlet duct 12 fitted to the rear supporter 9 for serving as a passage for supplying hot air to the drying drum 1, the guide funnel 20 fitted to an inlet side of the inlet duct 12, a mixing pipe 24 fitted to an inlet side of the guide funnel 20, for mixing the gas sprayed from a gas nozzle 22 and primary air, the gas nozzle 22 fitted to a position opposite to the inlet of the mixing pipe 24, a valve 30 fitted for controlling supply and supply rate of the gas to the gas nozzle 22, and an igniter 26 at a fore end of the mixing pipe 24 for igniting mixture gas.

In this case, it is preferable that the grooves 200 in left and right sides of the outlet part of the guide funnel 20, and the projections on the inlet side of the inlet duct 12 are in “V” forms.

The operation of the present invention will be described.

Since the guide funnel 20 of the present invention is cylindrical, with “V” grooves 200 respectively recessed into a flow passage in left and right sides of the guide funnel 20, and an inlet side of an inlet duct 12 the outlet part of the guide funnel 20 is inserted thereto has “V” projections 120 fit to the “V” grooves 200 in the guide funnel 20, when the guide funnel 20 is fitted to the inlet of the inlet duct 12, the “V” projections 120 on the inlet duct 12 are positioned inside of the “V” grooves 200 of the guide funnel 20.

Therefore, as the guide funnel is prevented from being fluid by an interference of the “V” projections 120 on the inlet duct 12, the fitting of components becomes easy.

In the meantime, different from above, the projections may be formed on the outlet part of the guide funnel 20, and the grooves may be formed in the inlet side of the inlet duct 12.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

That is, though above embodiment describes that the grooves in both left and right sides of the outlet part of the guide funnel 20, and the projections 120 in the inlet side of the inlet duct 12 fit to the grooves have “V” forms, forms of the grooves and the projections are not limited to the “V” forms, but any form may be adequate as far as the forms are fit to each other without interference.

Accordingly, the present invention has the following advantages or effects.

As has been described, the present invention is related to a clothes dryer, in which a fitting structure of a guide funnel to an inlet duct of a gas combustion device for burning a gas to produce hot air for drying a drying object introduced into a drying drum is improved.

That is, the present invention has an advantage of improving workability of the fitting work by preventing the guide funnel from being fluid in fitting the guide funnel to the inlet duct.

What is claimed is:

1. A fitting structure of a guide funnel to an inlet duct of a gas combustion device in a clothes dryer, comprising:
grooves respectively recessed into a flow passage in left/right sides of an outlet part of the guide funnel; and
projections respectively fit to the grooves in the guide funnel on an inlet side of an inlet duct the outlet part of the guide funnel is inserted thereto,
the clothes dryer having a drying drum for introduction of a drying object therein, a rear supporter for supporting a rear part of the drying drum, the inlet duct fitted to the rear supporter for serving as a passage for supplying hot air to the drying drum, the guide funnel fitted to an inlet side of the inlet duct, a mixing pipe fitted to an inlet side of the guide funnel, for mixing the gas sprayed from a gas nozzle and primary air, the gas nozzle fitted to a position opposite to the inlet of the mixing pipe, a valve fitted for controlling supply and supply rate of the gas to the gas nozzle, and an igniter at a fore end of the mixing pipe for igniting mixture gas.

2. The fitting structure as claimed in claim 1, wherein the grooves in both the left and right sides of the outlet part of the guide funnel and the projections fit to the grooves have “V” forms.
